(19) United States
(12) Patent Application Publication
(10) Pub. No.: US 2024/0391246 A1
(43) Pub. Date: Nov. 28, 2024

(54) DEGASSING DEVICE AND INKJET RECORDING APPARATUS

(71) Applicant: KYOCERA Document Solutions Inc., Osaka (JP)

(72) Inventor: Hideki ISHIDA, Osaka-shi (JP)

(73) Assignee: KYOCERA Document Solutions Inc., Osaka (JP)

(21) Appl. No.: 18/668,078

(22) Filed: May 17, 2024

(30) Foreign Application Priority Data
May 24, 2023 (JP) 2023-085489

(51) Int. Cl. B41J 2/19

(52) U.S. Cl. CPC B41J 2/19

(57) ABSTRACT

A degassing device removes air dissolved in a liquid under a pressure decreased atmosphere, and includes one or more liquid tanks, a pressure decreasing device, and an inflow pass. One or more liquid tanks store the liquid. The pressure decreasing device decreases pressure in the liquid tank. The inflow pass allows the liquid to be flowed into the liquid tank due to a negative pressure in the pressure decreased liquid tank.

### INCORPORATION BY REFERENCE

This application is based on and claims the benefit of priority from Japanese patent application No. 2023-085489 filed on May 24, 2023, which is incorporated by reference in its entirety.

### BACKGROUND

The present disclosure relates to a degassing device and an inkjet recording apparatus.

In an inkjet recording apparatus, when an amount of dissolved gas of ink increases, bubbles may be generated inside a recording head, causing an ejection failure. Therefore, a technique for decreasing the amount of dissolved gas in ink has been studied. For example, there has been proposed a configuration in which ink in an ink tank is stirred under a state where pressure in the ink tank is decreased to degas the ink.

In the above-described system, in order to rotate the stirrer, it is necessary to provide a mechanism for rotating a magnet rotor on the outside of the ink tank. Since the stirrer is restricted by the magnetic field generated by the magnet rotor, it is considered that the stirrer is released from the restriction of the magnetic field when it is subjected to vibration during transport of the apparatus or when the rotation speed of the magnet rotor is increased. Therefore, it is necessary for the ink tank to be provided with a mechanism to prevent the release of the stirrer. Further, since the decreased pressure of the ink tank affects the meniscus of the recording head, there is a restriction that the ink cannot be supplied to the recording head during the pressure decreasing.

### SUMMARY

A degassing device according to the present disclosure removes air dissolved in a liquid under a pressure decreased atmosphere, and includes one or more liquid tanks, a pressure decreasing device, and an inflow pass. One or more liquid tanks store the liquid. The pressure decreasing device decreases pressure in the liquid tank. The inflow pass allows the liquid to be flowed into the liquid tank due to a negative pressure in the pressure decreased liquid tank.

An inkjet recording apparatus according to the present disclosure includes the degassing device and a recording head which ejects the liquid degassed by the degassing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an inkjet recording apparatus according to one embodiment of the present disclosure.

FIG. 2 is a schematic view showing an ink supply configuration according to the embodiment of the present disclosure.

FIG. 3 is a schematic view showing the ink supply configuration according to the embodiment of the present disclosure.

FIG. 4 is a schematic view showing the ink supply configuration according to the embodiment of the present disclosure.

FIG. 5 is a schematic view showing the ink supply configuration according to the embodiment of the present disclosure.

FIG. 6 is a schematic view showing the ink supply configuration according to the embodiment of the present disclosure.

FIG. 7 is a schematic view showing the ink supply configuration according to a first modified example of the embodiment of the present disclosure.

FIG. 8 is a schematic view showing the ink supply configuration according to a second modified example of the embodiment of the present disclosure.

FIG. 9 is a schematic view showing the ink supply configuration according to a third modified example of the embodiment of the present disclosure.

FIG. 10 is a graph showing a degassing performance when a number of inflow port is varied.

FIG. 11 is a view showing one example of a plurality of inflow ports according to a fourth modified example of the embodiment of the present disclosure.

FIG. 12 is a view showing another example of the plurality of inflow ports according to the fourth modified example of the embodiment of the present disclosure.

FIG. 13 is a view showing one example in which the ink is jetted in a form of shower, in the fourth modified example of the embodiment of the present disclosure.

FIG. 14 is a graph showing a degassing performance when the ink is jetted in a form of shower.

FIG. 15 is a graph showing a degassing performance when an opening diameter of the inflow port and a number of the inflow port are adjusted.

### DETAILED DESCRIPTION

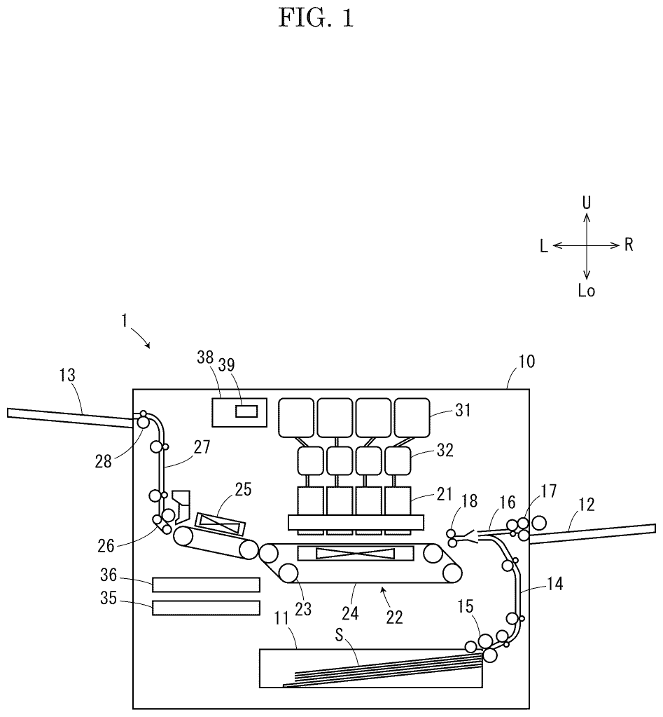

Hereinafter, with reference to the drawings, an inkjet recording apparatus 1 of the present embodiment will be described. FIG. 1 is a schematic view showing the inkjet recording apparatus 1 according to the present embodiment. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

An inkjet recording apparatus 1 ejects ink from each inkjet recording head 21 toward a sheet S as a recording medium and performs printing. The inkjet recording apparatus 1 includes a box-shaped housing 10 in which various kinds of device are housed. In the lower portion of the housing 10, a sheet feeding cassette 11 in which the sheet S is set is housed, and a manual sheet feeding tray 12 on which the sheet S is set by hand is installed on the right side surface of the housing 10. On the upper portion of the left side surface of the housing 10, a sheet discharge tray 13 on which the recorded sheet S is stacked is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a registration roller 18 which adjusts the feeding timing of the sheet S is provided in the downstream portion of the first conveyance path 14. Further, a sheet feeding path 16 of the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the registration roller 18, a conveying device 22 and the recording head 21 provided for each color (for example, black, cyan, magenta, and yellow) are installed. The registration roller 18 corrects the skew of the sheet S and then sends the sheet S to the conveying device 22 in accordance with the ink ejecting operation by each recording head 21. In the housing 10, an ink container 31 and an ink tank 32 for each recording head 21 are provided. The ink of each ink container 31 is temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink of the sheet S is provided. On the downstream side of the drying device 25, a decurl device 26 which corrects the curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be composed of a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording, the sheet S is fed from the sheet feeding cassette 11 and the manual sheet feeding tray 12 by the first sheet feeding part 15 and the second sheet feeding part 17, respectively, and then sent to the registration roller 18. In accordance with the ejecting timing of the ink, the sheet S is conveyed from the registration roller 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded sheet S is discharged to the sheet discharge tray 13 by the sheet discharge part 28.

By the way, the liquid surface of the ink touches the air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiver filter in a state where the pressure of the circumference of the hollow fiber filter is decreased, the air is moved from the wall surface of the hollow fiber to the pressure decreased side to degas the ink. This method requires the expensive hollow fiber filter and requires periodic replacement operations, which increase cost.

In order to prevent the clogging of the nozzle, a method (hereinafter referred to as the stirring degassing method) has been proposed in which the ink is stirred by the stirrer in a state in which the pressure in the ink tank 32 is decreased below an atmospheric pressure to degas the ink. In the stirring degassing system, a magnetic force is externally applied to the stirrer in the ink tank 32, and the stirrer is rotated by the magnetic force to stir the ink in the ink tank 32. When the depth of the ink and the tank diameter are large, the ink is difficult to be stirred, and the degassing efficiency is lowered. As the rotational speed of the stirrer is increased, the stirring becomes easier, but when the rotational speed of the stirrer becomes too high, a detuning phenomenon occurs and the rotational sound of the stirrer becomes large. Therefore, in the present embodiment, a pressure decreased inflow degassing method shown below is adopted.

[Degassing Device] A degassing device 40 according to the present embodiment removes air dissolved in the liquid under a decreased pressure atmosphere. The degassing device 40 includes a liquid tank (for example, an ink tank 32A) in which the liquid is stored, a pressure decreasing device (for example, a pressure decreasing pump 62) which decreases a pressure in the liquid tank, and an inflow pass 47 through which the liquid is flowed into the liquid tank due to a negative pressure of the pressure decreased liquid tank. Specifically, they are as follows.

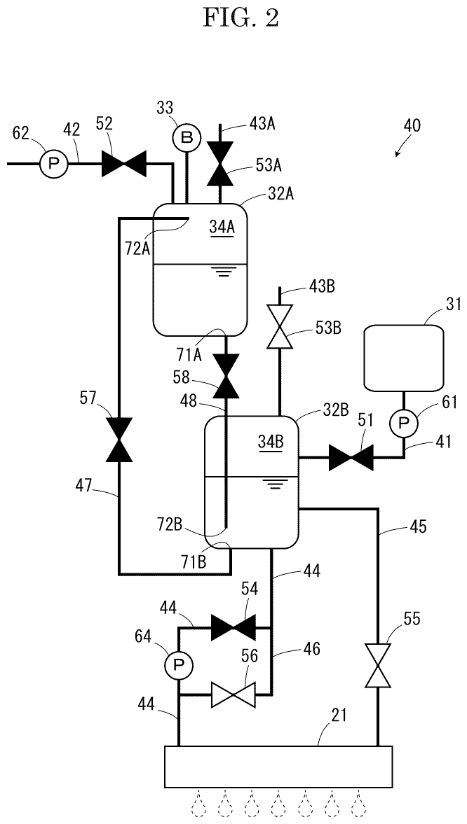

FIG. 2 is a schematic view showing an ink supply configuration according to the present embodiment. Although the inkjet recording apparatus 1 according to the present embodiment is provided with the ink supply configuration for each color of the ink, one ink supply configuration will be described here because these ink supply configurations have the same configuration. In the symbol showing a valve (a supply valve 51, and the others), the black symbol shows a closed state, and the white symbol shows an opened state.

[Ink Tank] The ink tanks 32A, 32B each has a shape in which an upper end portion and a lower end portion of a cylinder whose axial direction is along the upper-and-lower direction are closed, for example. The horizontal cross section of each of the ink tanks 32A, 32B is preferably circular. The ink tank 32B is disposed below the ink tank 32A. In the ink tank 32B, the ink replenished from the ink container 31 is stored. In the ink tank 32A, the ink flowed from the ink tank 32B in the inflow degassing processing as described below is stored.

FIG. 1 and the others are schematically drawn, and the recording head 21 is actually disposed above the ink tank 32B. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32B into the recording head 21.

[Replenishment Flow Pass] A replenishment flow pass 41 communicates with the ink container 31 and the ink tank 32B. On the replenishment flow pass 41, a replenishment pump 61 and a replenishment valve 51 are provided.

[Air Release Flow Pass] An air release flow pass 43A is connected to the top portion of the ink tank 32A, and communicates with an upper space 34A which is a space above the liquid surface of the liquid in the ink tank 32A. On the air release flow pass 43A, an air release valve 53A is provided.

The air release flow pass 43A is connected to the top portion of the ink tank 32B, and communicates with an upper space 34B which is a space above the liquid surface of the liquid in the ink tank 32B. On the air release flow pass 43B, an air release valve 53B is provided.

[Pressure Decreasing Flow Pass] A pressure decreasing flow pass 42 is connected to the top portion of the ink tank 32A, and communicates with the upper space 34A of the ink tank 32A. On the pressure decreasing flow pass 42, a pressure decreasing pump 62 and a pressure decreasing valve 52 are provided.

[Supply Flow Pass] A supply flow pass 44 communicates with the ink tank 32B and the recording head 21. One end portion of the supply flow pass 44 is connected to the bottom portion of the ink tank 32B. On the supply flow pass 44, a supply valve 54 and a supply pump 64 are provided.

[Recovery Flow Pass] A recovery flow pass 45 communicates with the ink tank 32B and the recording head 21. On the recovery flow pass 45, a recovery valve 55 is provided.

[Bypass Flow Pass] The supply flow pass 44 includes a bypass flow pass 46 bypassing the supply valve 54 and the supply pump 64. On the bypass flow pass 46, a bypass valve 56 is provided.

[Inflow Pass] An inflow pass 47 communicates with the ink tank 32B and the ink tank 32A. An outflow port 71B from the ink tank 32B to the inflow pass 47 is connected to the bottom portion of the ink tank 32B. The inflow pass 47 may penetrate the side wall portion or the top portion of the ink tank 32A. An inflow port 72A from the inflow pass 47 to the ink tank 32B may be protruded into the upper space 34A. The inflow pass 47 may be connected to the bottom portion or the side wall portion of the ink tank 32A, and protruded below the liquid surface after the ink is flowed into the ink tank 32A. On the inflow pass 47, an inflow valve 57 is provided.

[Return Flow Pass] A return flow pass 48 communicates with the ink tank 32B and the ink tank 32A. An outflow port 71A from the ink tank 32A to the return flow pass 48 is connected to the bottom portion of the ink tank 32A. The return flow pass 48 penetrates the top portion of the ink tank 32B. An inflow port 72B from the return flow pass 48 to the ink tank 32B reaches near the bottom portion of the ink tank 32B, and is positioned below the liquid surface. On the return flow pass 48, a return valve 58 is provided.

[Control Device] The replenishment pump 61, the pressure decreasing pump 62, the supply pump 64, the replenishment valve 51, the pressure decreasing valve 52, the air release valve 53A, the air release valve 53B, the supply valve 54, the recovery valve 55, the bypass valve 56, the inflow valve 57, and the return valve 58 are controlled by the control device 38 (see FIG. 1). The control device 38 includes a determination part 39 which determines the necessity of the degassing operation in accordance with a leaving time of the ink.

[Barometer] The ink tank 32A is provided with a barometer 33 which measures an atmospheric pressure in the upper space 34A of the ink tank 32A. The control device 38 acquires atmospheric pressure data from the barometer 33.

Next, the basic operation of the degassing device 40 will be described (FIG. 2 to FIG. 6). Here, the standby state will be described as an initial state.

[Standby State] In the standby state (see FIG. 2), the replenishment valve 51, the pressure decreasing valve 52, the air release valve 53A, the supply valve 54, the inflow valve 57, and the return valve 58 are closed, and the air release valve 53B, the recovery valve 55, and the bypass valve 56 are opened. The ink is stored in the ink tank 32B, the liquid surface touches the air in the upper space 34 opened to the atmosphere, and then the air is dissolved in the ink with the lapse of time.

In the standby state, the determination part 39 of the control device 38 determines whether the degassing is necessary. For example, the control device 38 is provided with a timer, and the leaving time of the ink is measured by the timer. An amount of dissolved gas of the ink can be estimated from one or more parameters such as an atmospheric pressure, a temperature of the ink, and an elapsed time from the last printing. Therefore, the determination part 39 stores conversion information indicating a correspondence relationship between each parameter and the amount of dissolved gas of the ink, and estimates the amount of dissolved gas of the ink based on each parameter. In addition, the determination part 39 stores conversion information indicating a correspondence relationship between the amount of dissolved gas of the ink and the allowable time, and the allowable time is set based on the amount of dissolved gas of the ink. The allowable time is a time during which the printing is allowed without degassing even if the ink is left. For the conversion information indicating the correspondence relationship between each parameter and the amount of dissolved gas of the ink and the conversion information indicating the correspondence relationship between the amount of dissolved gas of the ink and the allowable time, map data, a lookup table, a conversion equation, and the like are used. These map data, lookup table, and conversion equation are obtained experimentally, empirically, and theoretically in advance.

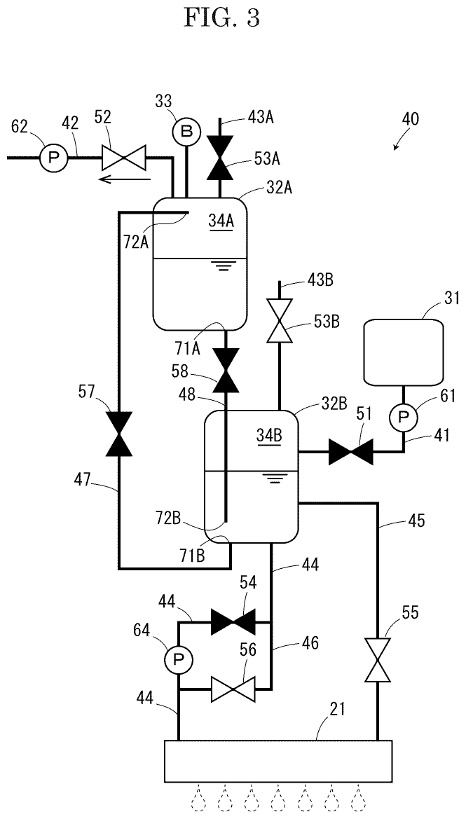

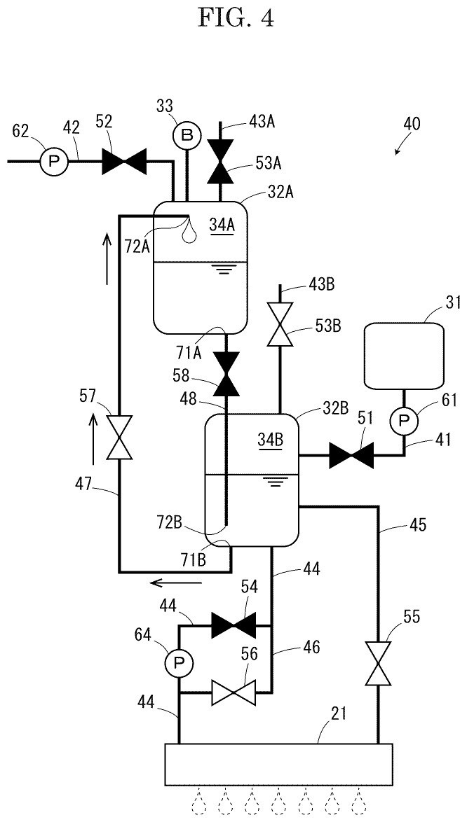

When the leaving time of the ink is within the allowable time, the determination part 39 determines that the degassing is unnecessary because an oxygen saturation degree is low. When the leaving time of the ink exceeds the allowable time, the determination part 39 determines that the degassing is necessary because the oxygen saturation degree is high. If the degassing is necessary, the control device 38 performs the pressure decreasing process.

[Pressure Decreasing Process] In the pressure decreasing process (see FIG. 3), the control device 38 opens the pressure decreasing valve 52, and drives the pressure decreasing pump 62. Then, the air is sucked out from the upper space 34 of the ink tank 32A, and the upper space 34A is decreased in pressure. The control device 38 closes the pressure decreasing valve 52 and stops the pressure decreasing pump 62 when the atmospheric pressure in the upper space 34 indicated by the barometer 33 reaches a target value (for example, −50 [kPa]) (see FIG. 2).

[Inflow Degassing Process] When the pressure decreasing process is completed, the control device 38 performs the inflow degassing process (see FIG. 4). In the inflow degassing process, the control device 38 opens the inflow valve 57. Then, since the upper space 34A of the ink tank 32A is decreased in pressure, the ink is sucked from the ink tank 32B to the ink tank 32A through the inflow pass 47. An amount of the ink to be sucked at one time is determined by various conditions such as a head difference between the ink tank 32A and the ink tank 32B, a pressure difference between the upper space 34A and the outside of the ink tank 32A, and the others, but it is also possible to be set such that substantially the total amount of the stored ink is sucked. The ink having a large amount of dissolved gas in the ink tank 32B flows out to the inflow pass 47 through the outflow port 71B, and flows into the upper space 34A of the ink tank 32A through the inflow port 72A. Since the pressure of the upper space 34A is decreased, the air dissolved in the ink escapes from the surface of the ink, thereby degassing the ink. Here, substantially the total amount means the total amount of the ink excluding the ink in the form of water droplets remaining on the wall surface and the bottom surface of the ink tank 32B without being discharged from the ink tank 32B.

[Pressure Decreasing Holding Process] When the inflow degassing process is completed, the control device 38 shifts to the pressure decreasing holding process (see FIG. 2). In the pressure decreasing holding process, the control device 38 closes the inflow valve 57. Then, since the pressure decreased state in the upper space 34A is held, the degassing of the ink is continued.

In the pressure decreasing holding process, the surface area of the ink in the upper space 34A is equal to the area of the liquid surface, but in the inflow degassing process, the surface area of the ink in the upper space 34A increases by the amount of the surface area of the ink falling from the inflow port 72A toward the liquid surface when the inflow port 72A is higher than the liquid surface, thereby improving the degassing efficiency. When the inflow port 72A is higher than the liquid surface, in the inflow degassing process, the ink stored in the ink tank 32A is stirred by the ink fallen from the inflow port 72A, and the replacement of the ink having a large amount of dissolved gas near the bottom surface of the ink tank 32A with the ink having a small amount of dissolved gas near the liquid surface is promoted, thereby further improving the degassing efficiency. Further, when the inflow port 72A is lower than the liquid surface, in the inflow degassing process, the stored ink is stirred by the flowed ink, thereby further improving the degassing efficiency. Therefore, the degassing efficiency is maximum in the inflow degassing process.

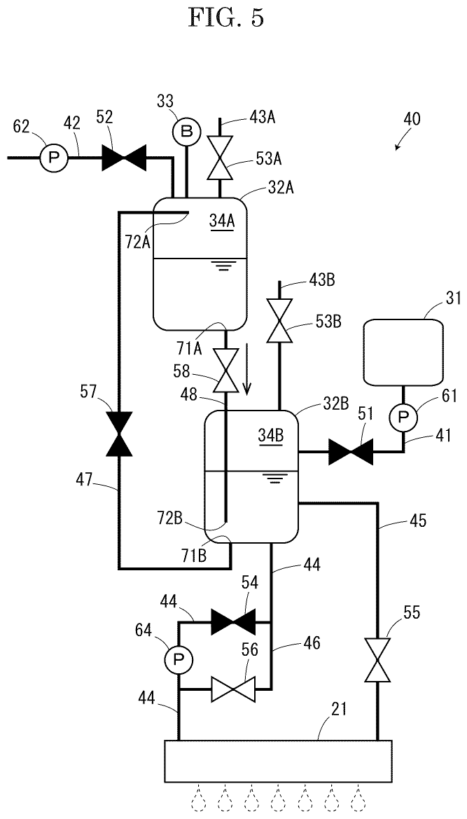

The length of time for performing the pressure decreasing holding process may be predetermined, but the pressure decreasing holding process may be continued until a print job is input. In this case, an upper limit value may be set to the length of time for continuing the pressure decreasing holding process.

[Return Process] When the pressure decreasing holding process is completed, the control device 38 shifts to the return process (see FIG. 5). In the return process, the control device 38 opens the air release valve 53A and the return valve 58. Then, since the upper space 34A is opened to the atmosphere, the degassed ink is returned from the ink tank 32A to the ink tank 32B through the return flow pass 48.

After the inflow degassing process, the determination part 39 determines the amount of dissolved gas, and when it is determined that the amount of dissolved gas is not decreased to a necessary degree, the return process may be performed to return the ink from the ink tank 32A to the ink tank 32B, and then the inflow degassing process may be performed again. Further, the inflow degassing process and the return process may be repeated several times until it is determined that the amount of dissolved gas is decreased to the necessary degree.

[Print Process] When the ink tank 32B is decreased in pressure while the recording head 21 and the ink tank 32B are communicated with each other, there is a risk that the meniscus in the nozzle is destroyed or that the ejection characteristics is changed due to the shape change of the meniscus. On the other hand, in the present embodiment, since the ink tank 32B is not decreased in pressure in the pressure decreasing process, the inflow degassing process, the pressure decreasing holding process, and the return process, there is no influence on the meniscus. Therefore, in the present embodiment, the print process can be performed in parallel with the pressure decreasing process, the inflow degassing process, the pressure decreasing holding process, and the return process. It should be noted that the print process may be performed at a timing different from the pressure decreasing process, the inflow degassing process, the pressure decreasing holding process, and the return process.

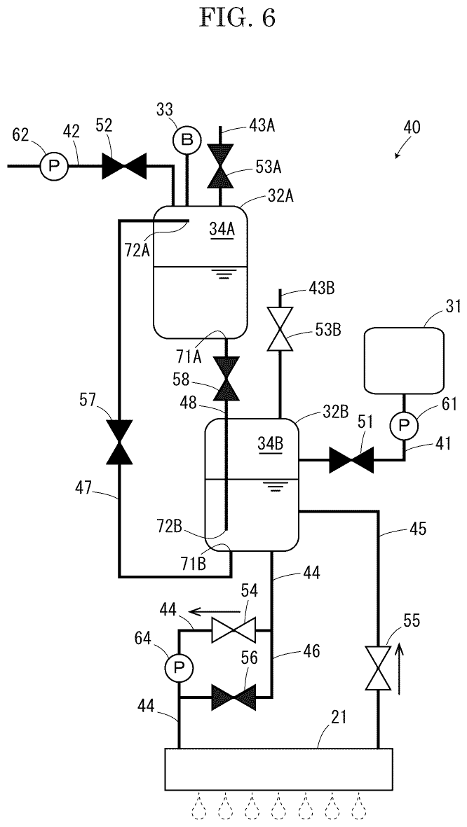

In the print process (see FIG. 2), the control device 38 closes the replenishment valve 51 and the supply valve 54, and opens the air release valve 53B, the recovery valve 55, and the bypass valve 56. Every time when the ink is ejected from the recording head 21, the ink is supplied from the ink tank 32B to the recording head 21 through the bypass flow pass 46 and the recovery flow pass 45. The recovery valve 55 may be closed, and the ink may be supplied to the recording head 21 only from the bypass flow pass 46.

[Head Circulation Process] The head circulation process can also be performed in parallel with the pressure decreasing process, the inflow degassing process, the pressure decreasing holding process, and the return process. In the head circulation process (see FIG. 6), the control device 38 closes the replenishment valve 51 and the bypass valve 56, opens the air release valve 53B, the supply valve 54, and the recovery valve 55, and drives the supply pump 64. Then, the ink is supplied from the ink tank 32B to the recording head 21 through the supply flow pass 44, and the ink is recovered from the recording head 21 to the ink tank 32B through the recovery flow pass 45. By circulating the ink between the recording head 21 and the ink tank 32B, the ink with increased viscosity is replaced in the recording head 21 and bubbles are removed from the recording head 21.

In some cases, the ink is replenished during the print process and the head circulation process. When the ink is replenished, the control device 38 opens the replenishment valve 51 and drives the replenishment pump 61. The ink is replenished from the ink container 31 to the ink tank 32B through the replenishment flow pass 41.

The degassing device 40 according to the embodiment described above removes air dissolved in the liquid under a pressure decreased atmosphere. The degassing device 40 includes the liquid tank (for example, the ink tank 32A) in which the liquid is stored, the pressure decreasing device (for example, the pressure decreasing pump 62) which decreases the pressure of the inside of the liquid tank, and the inflow pass 47 through which the liquid is flowed into the liquid tank by a negative pressure in the pressure decreased liquid tank. According to this configuration, since the gas escapes from the surface of the liquid in the liquid tank to the upper space 34A, the liquid can be degassed. When the inflow port 72A is higher than the liquid surface, the surface area of the ink in the upper space 34A increases by the amount of the surface area of the ink falling from the inflow port 72A toward the liquid surface in addition to the area of the liquid surface, thereby improving the degassing efficiency. When the inflow port 72A is higher than the liquid surface, the stored ink is stirred by the fallen ink, thereby further improving the degassing efficiency. Also, when the inflow port 72A is lower than the liquid surface, the stored ink is stirred by the ink flowing in, thereby further improving the degassing efficiency. Further, a driving force for allowing the liquid to flow into the liquid tank is unnecessary. Therefore, according to the present embodiment, the highly efficient degassing can be performed with a simple configuration.

Further, according to the degassing device 40 according to the present embodiment, a plurality of the liquid tanks (for example, the ink tanks 32A, 32B) are provided, the pressure decreasing device is provided in any one of the liquid tanks, and the inflow pass 47 allows the liquid to flow from the liquid tank which is not decreased in pressure to the liquid tank which is decreased in pressure by the pressure decreasing device. According to this configuration, the degassing is performed in the liquid tank which is decreased in pressure, but since the other liquid tanks are not decreased in pressure, the liquid can be supplied to the outside. Therefore, the degassing can be performed in parallel with the supply of the liquid.

The inkjet recording apparatus 1 according to the present embodiment includes the degassing device 40 and the recording head 21 which ejects the liquid degassed by the degassing device 40 to the sheet S. According to this configuration, it is possible to suppress the deterioration of image quality caused by bubbles.

The above embodiment may be modified as follows.

### First Modified Example

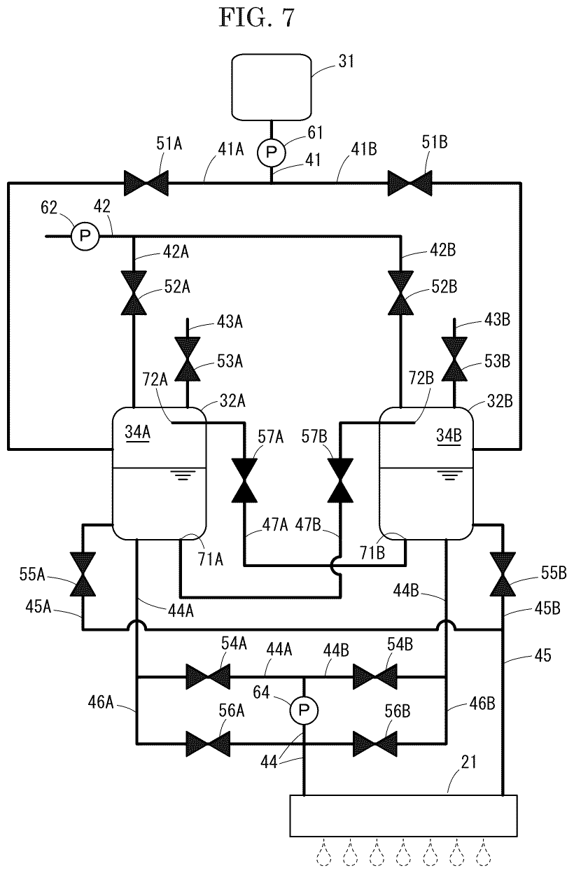

FIG. 7 is a schematic diagram showing the ink supply configuration according to the first modified example of the above embodiment. The degassing device 40 according to the present modified example includes a plurality of the liquid tanks, a plurality of inflow passes 47A, 47B, each of which communicates with any two liquid tanks, and the control device 38 which controls the pressure decreasing device and the plurality of inflow passes 47A, 47B. The control device 38 controls the pressure decreasing device such that any one liquid tank is decreased in pressure, and controls the inflow passes 47A, 47B such that the liquid is flowed from any one liquid tank which is not decreased in pressure into the liquid tank which is decreased in pressure by the pressure decreasing device. Hereinafter, the difference from the above embodiment will be described.

[Replenishment Flow Pass] The replenishment flow pass 41 branches into a replenishment flow pass 41A and a replenishment flow pass 41B. The replenishment flow passes 41A, 41B are connected to the ink tanks 32A, 32B, respectively. The replenishment pump 61 is provided in the replenishment flow pass 41. On the replenishment flow passes 41A, 41B, replenishment valves 51A, 51B are provided, respectively.

[Pressure Decreasing Flow Pass] The pressure decreasing flow pass 42 branches into a pressure decreasing flow pass 42A and a pressure decreasing flow pass 42B. The pressure decreasing flow pass 42A is connected to the top portion of the ink tank 32A, and communicates with the upper space 34A of the ink tank 32A. The pressure decreasing flow pass 42B is connected to the top portion of the ink tank 32B, and communicates with the upper space 34B of the ink tank 32B. The pressure decreasing pump 62 is provided in the pressure decreasing flow pass 42. On the pressure decreasing flow passes 42A, 42B, pressure decreasing valves 52A. 52B are provided, respectively.

[Supply Flow Pass] Supply flow passes 44A, 44B are connected to the ink tanks 32A, 32B, respectively. The supply flow passes 44A, 44B are merged with the supply flow pass 44. The supply flow pass 44 is connected to the recording head 21. On the supply flow passes 44A, 44B, supply valves 54A, 54B are provided, respectively. The supply pump 64 is provided in the supply flow pass 44.

[Recovery Flow Pass] Recovery flow passes 45A, 45B are connected to the ink tanks 32A, 32B, respectively. The recovery flow passes 45A, 45B are merged with the recovery flow pass 45. The recovery flow pass 45 is connected to the recording head 21. On the recovery flow passe 45A, 45B, recovery valves 55A, 55B are provided, respectively.

[Bypass Flow Pass] The supply flow passes 44A, 44 includes a bypass flow pass 46A which bypasses the supply valve 54A and the supply pump 64. The supply flow passes 44B, 44 includes bypass flow pass 46B which bypasses the supply valve 54B and the supply pump 64. On the bypass flow passes 46A, 46B, bypass valves 56A, 56B are provided, respectively.

[Inflow Pass] The inflow pass 47A communicates with the ink tank 32B and the ink tank 32A. The outflow port 71B from the ink tank 32B to the inflow pass 47A is connected to the bottom portion of the ink tank 32B. The inflow pass 47A penetrates the side wall portion or the top portion of the ink tank 32A. The inflow port 72A from the inflow pass 47 to the ink tank 32A protrudes into the upper space 34A. On the inflow pass 47A, an inflow valve 57A is provided.

The inflow pass 47B communicates with the ink tank 32A and the ink tank 32B. The outflow port 71A from the ink tank 32A to the inflow pass 47B is connected to the bottom portion of the ink tank 32A. The inflow pass 47B penetrates the side wall portion or the top portion of the ink tank 32B. The inflow port 72B from the inflow pass 47B to the ink tank 32B protrudes into the upper space 34B. On the inflow passe 47B, an inflow valve 57B is provided.

Next, the operation of the inflow degassing process of the present modified example will be described. When the degassing is performed in the ink tank 32A, the control device 38 first opens the pressure decreasing valve 52A, and drives the pressure decreasing pump 62 to decreases the pressure of the inside of the ink tank 32A. When the pressure reaches the predetermined negative pressure, the control device 38 closes the pressure decreasing valve 52A and stops the pressure decreasing pump 62. Next, the control device 38 opens the air release valve 53B and the inflow valve 57A. Then, the ink is sucked from the ink tank 32B to the ink tank 32A through the inflow pass 47A, and the degassing is performed in the upper space 34A.

On the other hand, when the degassing is performed in the ink tank 32B, the control device 38 decreases the pressure of the inside of the ink tank 32B, and then opens the air release valve 53A and the inflow valve 57B. Then, the ink is sucked from the ink tank 32A to the ink tank 32B through the inflow pass 47B, and the degassing is performed in the upper space 34B.

After the degassing is performed in one of the two liquid tanks, the determination part 39 determines the amount of dissolved gas, and when it is determined that the amount of dissolved gas is not decreased to a necessary degree, the ink may be flowed into the other liquid tank to perform the degassing. The degassing may be alternately performed in the two liquid tanks until it is determined that the amount of dissolved gas is decreased to the necessary degree.

The ink can be supplied to the recording head 21 in parallel with the above operation of degassing and inflow. When the degassing is performed in the ink tank 32A, the bypass valve 56B and the recovery valve 55B are opened to supply the ink to the recording head 21. When the degassing is performed in the ink tank 32B, the bypass valve 56A and the recovery valve 55A are opened to supply the ink to the recording head 21.

As described above, the maximum degassing efficiency is achieved when the liquid is flowed in due to the pressure decreasing, but the length of time required for the liquid flow in is limited. On the other hand, according to the present modified example, the degassing and inflow can be performed alternately in the plurality of liquid tanks. As a result, the maximum efficient degassing is repeated, and the time required for degassing can be shortened. Further, since the liquid can be supplied to the outside from the liquid tank which is not decreased in pressure, the time for interrupting the liquid supply can be reduced.

Further, as a modification of the first modified example, one inflow pass may be provided for communicating the ink tank 32A with the ink tank 32B. The inflow pass may be connected to the bottom portion of the ink tank 32A and the bottom portion of the ink tank 32B. The inflow pass may not be provided with a valve, but may be controlled by a valve. In either configuration, although the degassing efficiency is lower than that of the first modified example, the degassing can be performed.

### Second Modified Example

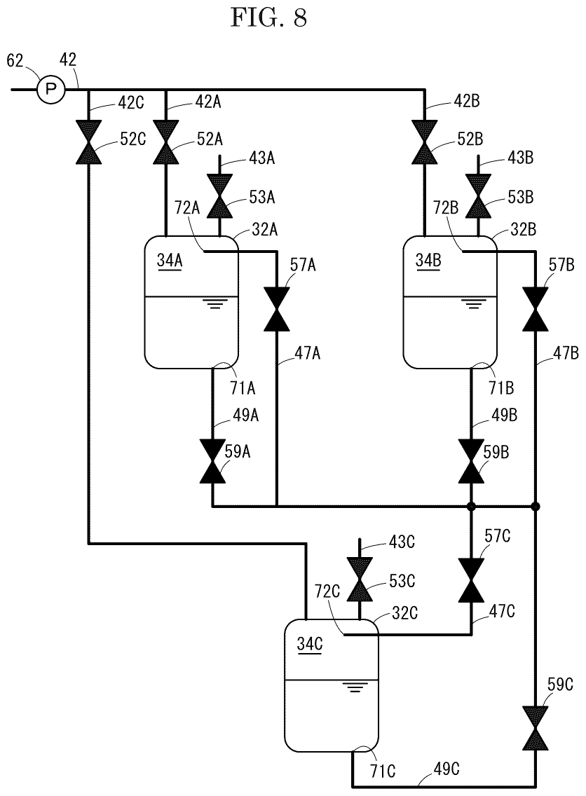

FIG. 8 is a schematic view showing then ink supply configuration according to the second modified example of the above embodiment. The degassing device 40 according to the present modified example includes three or more liquid tanks, the control device 38 controls the pressure decreasing device such that the pressure of any one of the liquid tanks is decreased, and controls the plurality of inflow passes 47A, 47B, and 47C such that the liquid is flowed from any one of the liquid tank which is not decreased in pressure into the liquid tank which is decreased in pressure by the pressure decreasing device. This modified example includes the configuration in which the ink is replenished from the ink container 31 and the configuration in which the ink is supplied to the recording head 21, in the same manner as in the first modified example, but the description and illustration thereof are omitted.

[Ink Tank] The degassing device 40 includes the ink tank 32A, 32B, and further an ink tank 32C having the same configuration as the ink tanks 32A, 32B.

[Pressure Decreasing Flow Pass] The pressure decreasing flow pass 42 branches into a pressure decreasing flow pass 42A, a pressure decreasing flow pass 42B, and a pressure decreasing flow pass 42C. The pressure decreasing flow pass 42C is connected to the top portion of the ink tank 32C, and communicates with the upper space 34C of the ink tank 32C. On the pressure decreasing flow pass 42C, a pressure decreasing valve 52C is provided.

[Outflow Pass, Inflow Pass] Outflow passes 49A, 49B, and 49C are connected to the bottom portions of the ink tanks 32A, 32B, and 32C, respectively. The inflow passes 47A, 47B, and 47C penetrate the side wall portions or the top portions of the ink tanks 32A, 32B, and 32C, respectively. The outflow passes 49A, 49B, 49C and the inflow passes 47A, 47B, 47C communicate with each other. On the outflow passes 49A, 49B, and 49C, outflow valves 59A, 59B, and 59C are provided, respectively. On the inflow passes 47A, 47B, and 47C, inflow valves 57A, 57B, and 57C are provided, respectively.

Next, the operation of this modified example will be described. By opening one of the outflow valves 59A, 59B, and 59C and one of the inflow valves 57A, 57B, and 57C, the ink can flow from one of the ink tanks 32A, 32B, and 32C to the other one. Specifically, by opening the outflow valve 59A and the inflow valve 57B, the ink flows into the ink tank 32B from the ink tank 32A. By opening the outflow valve 59A and the inflow valve 57C, the ink flows into the ink tank 32C from the ink tank 32A. By opening the outflow valve 59B and the inflow valve 57A, the ink flows into the ink tank 32A from the ink tank 32B. By opening the outflow valve 59B and the inflow valve 57C, the ink flows into the ink tank 32C from the ink tank 32B. By opening the outflow valve 59C and the inflow valve 57A, the ink flows into the ink tank 32A from the ink tank 32C. By opening the outflow valve 59C and the inflow valve 57B, the ink flows into the ink tank 32B from the ink tank 32C.

In the first modified example, since two liquid tanks are provided, a period of interrupting supply of the liquid is generated when switching the liquid tank to be decreased in pressure. On the other hand, in the second modified example, since three liquid tanks are provided, one liquid tank can always supply the liquid. Therefore, according to the second modified example, the degassing can be performed without interrupting supply of the liquid. It should be noted that the same effect as in the present modified example is also achieved when four or more liquid tanks are provided.

After the degassing is performed in one of the three liquid tanks (for example, the ink tank 32A), the determination part 39 determines the amount of dissolved gas, and when it is determined that the amount of dissolved gas is not decreased to a necessary degree, the ink may be flowed into another liquid tank (for example, the ink tank 32B) to perform the degassing. Further, until it is determined that the amount of dissolved gas is decreased to the necessary degree, the ink may be moved to the three liquid tanks in a predetermined order (for example, the order of the ink tank 32A, 32B, 32C, 32A, . . . ), and the degassing may be performed. Alternatively, until it is determined that the amount of dissolved gas is decreased to the necessary degree, the degassing may be performed alternately in two of the three liquid tanks.

### Third Modified Example

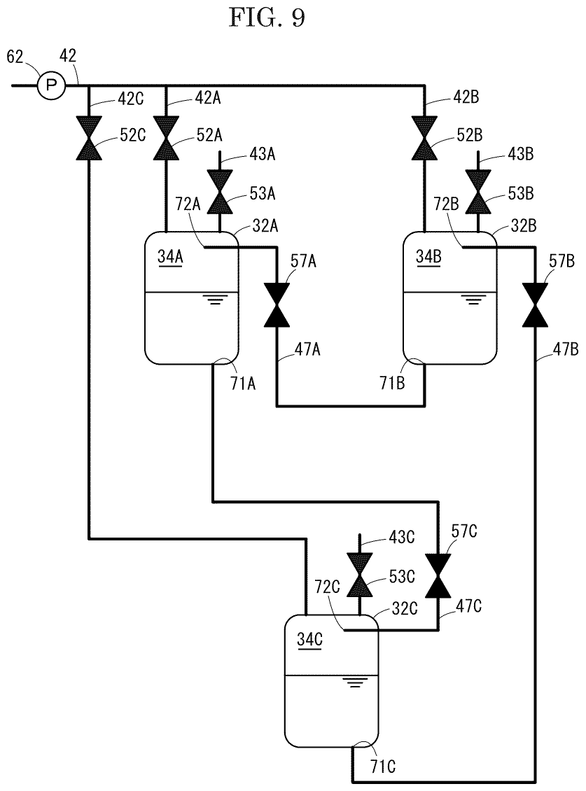

FIG. 9 is a schematic diagram showing the ink supply configuration according to the third modified example of the above embodiment. The degassing device 40 according to the present modified example also includes three or more liquid tanks, and the control device 38 controls the pressure decreasing device such that the pressure of the inside of any one liquid tank is decreased, and controls the inflow passes 47A, 47B, and 47C such that the liquid is flowed from any one liquid tank which is not decreased in pressure into the liquid tank which is decreased in pressure by the pressure decreasing device.

However, in this modified example, the configuration of the inflow passes 47A, 47B, and 47C is simplified compared with the second modified example. Specifically, the inflow passes 47A, 47B, and 47C penetrate the side wall portions or the top portions of the ink tanks 32A, 32B, and 32C, respectively. The inflow passes 47C, 47A, and 47B are connected to the bottom portions of the ink tanks 32A, 32B, and 32C, respectively. On the inflow passes 47A, 47B, and 47C, inflow valves 57A, 57B, and 57C are provided, respectively. With this configuration, only the inflow from the ink tank 32A to the ink tank 32C, the inflow from the ink tank 32C to the ink tank 32B, and the inflow from the ink tank 32B to the ink tank 32A are possible, and the inflows in the opposite directions to the above directions are not possible. If the inflow pass 47A is configured to connect the bottom portion of the ink tank 32A and the bottom portion of the ink tank 32B, the ink can flow between the ink tank 32A and the ink tank 32B. The same applies to the inflow passes 47B and 47C.

Next, the operation of this modified example will be described. When the degassing is performed in the ink tank 32A, the control device 38 decreases the pressure in the inside of the ink tank 32A, and then opens the inflow valve 57A while keeping the air release valve 53B closed. Then, the ink is sucked from the ink tank 32B to the ink tank 32A through the inflow pass 47A, and the degassing is performed in the upper space 34A.

The control device 38 continues the pressure decreasing by the pressure decreasing pump 62 even if almost all amount of the ink stored in the ink tank 32B flows into the ink tank 32A. Then, since the air release valve 53B is closed, the inside of the ink tank 32B is decreased in pressure. When the pressure of the inside of the ink tank 32B reaches a predetermined negative pressure, the control device 38 closes the inflow valve 57A and stops the pressure decreasing pump 62. In parallel with the above operation, the ink can be supplied from the ink tank 32C to the recording head 21.

Next, the control device 38 opens the inflow valve 57B while keeping the air release valve 53B closed. Then, the ink is sucked from the ink tank 32C into the ink tank 32B through the inflow pass 47B, and the degassing is performed in the upper space 34B.

As described above, the control device 38 controls the pressure decreasing device so as to maintain the pressure decreased state of the pressure decreased liquid tank after allowing the liquid to flow into the liquid tank which is decreased in pressure by the pressure decreasing device. According to this configuration, the degassing can be continued even after the inflow of the liquid.

In addition, the control device 38 controls the pressure decreasing device such that approximately all amount of the liquid stored in any one liquid tank which is not decreased in pressure is flowed into the liquid tank which is decreased in pressure by the pressure decreasing device and then the pressure of the inside of the liquid tank to which the liquid is flowed is decreased. According to this configuration, while the degassing is continued, the liquid tank from which approximately all amount of the liquid is flowed out is decreased in pressure through the inflow passes 47A, 47B, and 47C, so that the next inflow can be prepared.

After the degassing is performed in one of the three liquid tanks (for example, the ink tank 32A), the determination part 39 determines the amount of dissolved gas, and when it is determined that the amount of dissolved gas is not decreased to a necessary degree, the ink may be flowed into another liquid tank (for example, the ink tank 32B) to perform the degassing. Further, until it is determined that the amount of dissolved gas is decreased to the necessary degree, the ink may be moved to the three liquid tanks in a predetermined order (for example, the order of the ink tank 32A, 32B, 32C, 32A . . . ), and the degassing may be performed.

### Fourth Modified Example

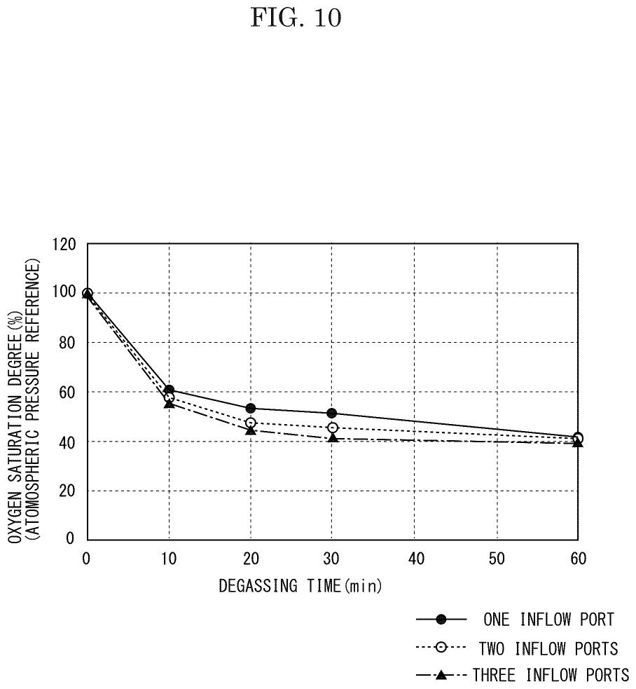

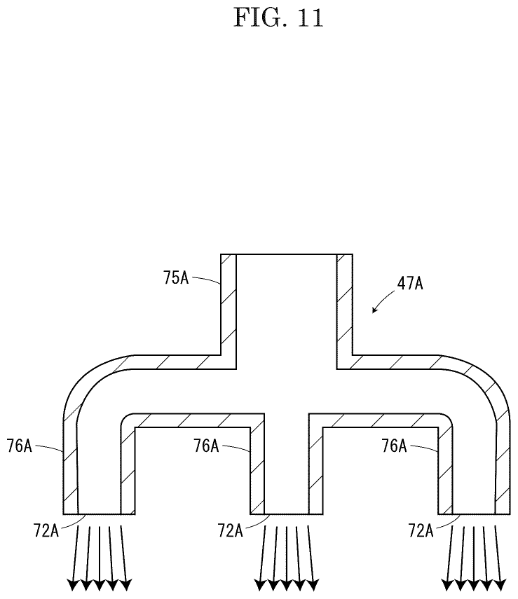

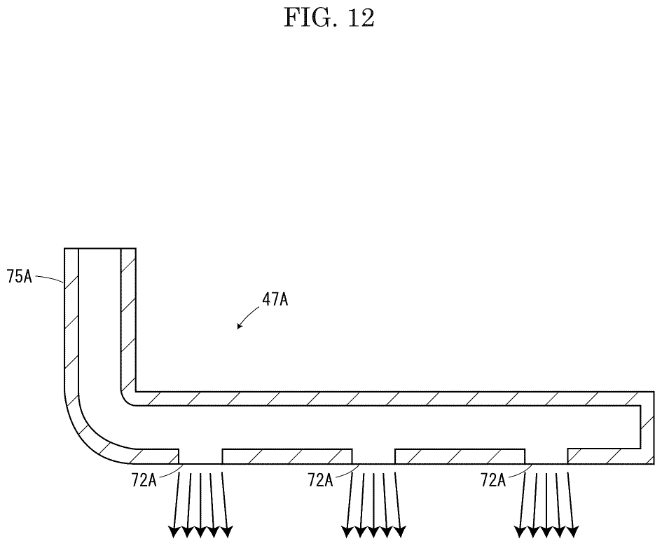

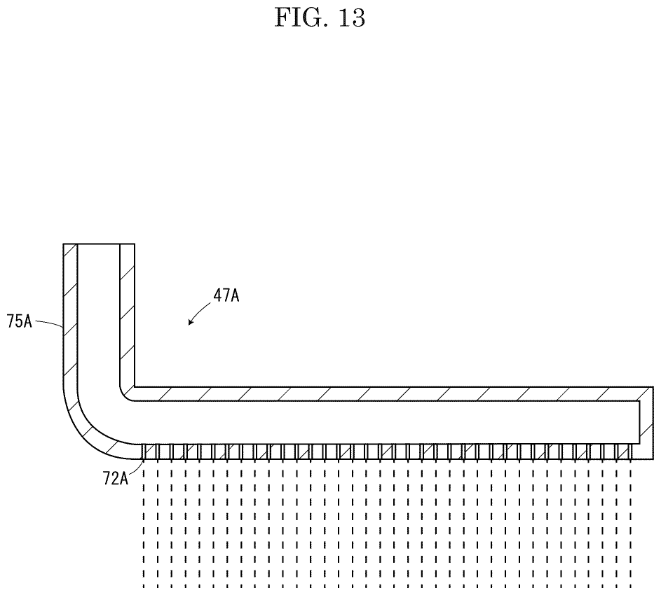

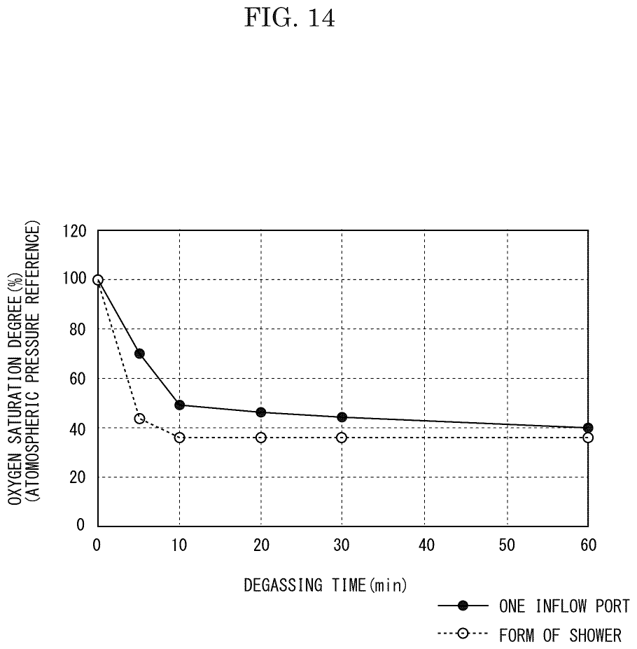

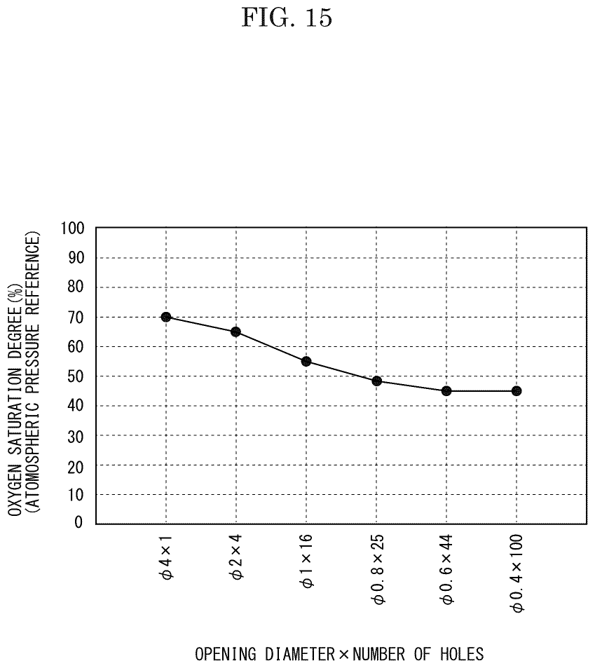

The fourth modified example is a modification for providing a plurality of the inflow ports 72. FIG. 10 is a graph showing the degassing performance when a number of the inflow ports 72 is varied. FIG. 11 shows an example of the plurality of inflow ports 72. FIG. 12 shows another example of the plurality of inflow ports 72. FIG. 13 is a view showing an example of jetting the ink in a form of shower. FIG. 14 is a graph showing the degassing performance when the ink is jetted in a form of shower. FIG. 15 is a graph showing the degassing performance when an opening diameter of the inflow port 72 and a number of inflow port 72 are adjusted.

The influence on the degassing performance when the plurality of inflow ports 72 are provided is confirmed using the ink supply configuration of the first modified example (see FIG. 7). The degassing performance is compared when a number of the inflow ports 72A and 72B is changed without changing the flow velocity, in a state where the viscosity of the ink is 7 [mPa·s], the temperature of the ink is 25 [° C.], the depth of the ink is 28 [mm], the tank diameter of the ink tanks 32A, 32B are 60 [mm], and the circulation flow rate of the ink is 770 [ml/min]. The inflow degassing process is performed while moving the ink alternately between the ink tank 32A and the ink tank 32B. In the cases where a number of the inflow ports 72A and 72B is one, two, and three, the change in oxygen saturation degree with the lapse of degassing time is measured by an existing measuring instrument. The oxygen saturation is expressed by the equation (1).

An oxygen saturation degree[%]=(an amount of the dissolved oxygen/an amount of saturated dissolved oxygen under atmospheric pressure)×100 equation (1).

As shown in FIG. 10, the oxygen saturation degree is decreased in the shortest time when a number of the inflow ports 72A, 72B are three, and it is confirmed that the degassing efficiency is improved as the number of the inflow ports 72A, 72B is increased. The degassing time shown in the graph is the time excluding the time required for switching the direction of the ink movement.

In the following description, an example in which the present modified example is applied to the inflow port 72A in the first modified example is shown, but the present modification can be applied to the inflow ports 72A, 72B, 72C, and the others in the above embodiments and all modified examples.

The plurality of inflow ports 72A may be formed so as to return the ink from the inflow pass 47A to the ink tank 32A. For example, as shown in FIG. 11, a downstream pipe 75A, which is the downstream portion of the inflow pass 47A, may be branched into a plurality of branch pipes 76A (branch passes), and the plurality of inflow ports 72A may be formed at the downstream end portions of the plurality of branch pipes 76A. According to this configuration, the plurality of branch pipes 76A improve the degree of freedom of layout of the plurality of inflow ports 72A, and generate a plurality of flows of the ink in the ink tank 32A. Further, as shown in FIG. 12, the plurality of inflow ports 72A may be formed side by side along the flow direction in the downstream pipe 75A of the inflow pass 47A. According to this configuration, the plurality of flows is generated in the ink tank 32A in a simple configuration. The plurality of inflow ports 72A may be formed side by side along the flow direction in the branch pipe 76A.

Next, the degassing performance when the ink is returned in a form of shower is confirmed. In a state where the viscosity of the ink is 7 [mPa·s], the temperature of the ink is 25 [° C.], the depth of the ink is 28 [mm], the tank diameter of the ink tank 32A is 60 [mm], and the circulating flow rate of the ink is 770 [ml/min], the degassing performance is compared between a case where the ink is returned from one inflow port 72A and a case where the ink is returned in a form of shower from the inflow ports 72A. Here, when the inflow port 72A is positioned 35 [mm] above the liquid surface, the change in oxygen saturation degree with the lapse of the degassing time is measured by an existing measuring instrument.

As shown in FIG. 13, a number of small holes as the plurality of inflow ports 72A are formed in the downstream pipe 75A of the inflow pass 47A. As a result, the ink is jetted in a form of shower. In this case, the ink is not fallen in a linear manner from the number of small holes, but is fallen in intermittent droplets from the number of small holes. By setting the circulation flow rate to be relatively large, the ink is jetted into a linear shape from the number of small holes, and then the ink is gathered to form an ink droplet by the surface tension. To produce the intermittent ink droplets, the opening diameter of the small hole and the circulating flow rate may be adjusted according to the viscosity, surface tension, or other physical properties of the ink.

As shown in FIG. 14, by returning the ink from the plurality of inflow ports 72A in the form of shower, a significant improvement in the degassing performance is obtained. This is because the ink is jetted in a form of shower from the plurality of inflow ports 72A, the ink is returned to the ink tank 32A in a form of intermittent ink droplets. Since the ink is shaped into an ink droplet form, the surface area of the ink exposed to the pressure decreased atmosphere increases, and the falling speed of the ink droplet decreases due to the air resistance, thereby increasing the time for the ink droplet to be exposed to the pressure decreased atmosphere. As a result, the degassing is promoted when the ink droplets fall from the plurality of inflow ports 72A. Further, since the falling speed of the ink droplet is reduced, foaming is difficult to occur.

Next, the degassing performance is confirmed when an opening diameter of each of the inflow ports 72A and a number of the inflow ports 72A are adjusted such that the total opening area of inflow ports 72A (small holes) is constant. In a state where the viscosity of the ink is 7 [mPa·s], the temperature of the ink is 25 [° C.], the depth of the ink is 28 [mm], the tank diameter of the ink tank 32A is 60 [mm], and the circulating flow rate of the ink is 770 [ml/min], the degassing performance is compared when the number of inflow ports 72A and the opening diameter are changed. Here, the number of inflow ports 72A and the opening diameter are adjusted such that the total opening area of the plurality of inflow ports 72A is about 12.5 [mm²], and the oxygen saturation degree is measured 5 minutes after the degassing is performed in a state in which the air is sufficiently dissolved in the ink.

As shown in FIG. 15, the oxygen saturation degree decreases when the opening diameter of each of the inflow ports 72 is from 4 [mm] to 0.8 [mm], but when the opening diameter of each of the inflow port 72A is 0.8 [mm] or less, the oxygen saturation degree becomes constant in a low state. The oxygen saturation degree is lowered when the number of inflow ports 72A is from 1 to 25, but when the number of inflow ports 72A is 25 or more, the oxygen saturation degree becomes constant at a low state. For this reason, the opening diameter of the inflow port 72A is preferably 0.8 [mm] or less, or the number of inflow ports 72A is preferably 25 or more. If the opening diameter of the inflow port 72A is 0.8 [mm] or less, the ink droplets are intermittently produced, and if the number of inflow ports 72A is 25 or more, the jet speed of the ink can be reduced.

According to the modified example described above, the inflow pass 47A includes the plurality of inflow ports 72A through which the liquid is flowed into the liquid tank. The plurality of inflow ports 72A allow the liquid to be flowed in in a form of shower. The opening diameter of the inflow port 72A is 0.8 [mm] or less. The number of the plurality of inflow ports 72A is 25 or more. According to these configurations, the degassing efficiency can be improved.

### ADDITIONAL MODIFICATION

In the above embodiment, an example in which the degassing device 40 is provided in the inkjet recording apparatus 1 is shown, but the degassing device 40 can also be applied to devices used in other fields such as semiconductor manufacturing fields and display manufacturing fields. That is, it can be applied to degassing of chemical solutions other than ink, electrolytic solutions, liquid resins, adhesives, solvents, lubricating oils, liquid foods, serum, or the like.

In the above embodiment, an example in which the pressure decreasing pump 62 is used as a pressure decreasing device is shown, but the pressure decreasing device may be a device capable of reducing pressure in the ink tank 32A, and for example, the pressure decreasing device may be an ejector.

1. A degassing device which removes air dissolved in a liquid under a pressure decreased atmosphere, the degassing device comprising:
one or more liquid tanks in which the liquid is stored;
a pressure decreasing device which decreases pressure in the liquid tank; and
an inflow pass which allows the liquid to be flowed into the liquid tank due to a negative pressure in the pressure decreased liquid tank.

2. The degassing device according to claim 1, comprising:
a plurality of the liquid tanks, wherein
the pressure decreasing device communicates with at least one of the liquid tanks, and
the inflow pass allows the liquid to be flowed from the liquid tank which is not decreased in pressure into the other liquid tank which is decreased in pressure by the pressure decreasing device.

3. The degassing device according to claim 1, comprising:
a plurality of the liquid tanks, wherein
the inflow pass allows any two or more of the liquid tanks to be communicated with each other.

4. The degassing device according to claim 1, comprising:
a plurality of the liquid tanks;
a plurality of the inflow passes, the inflow pass allowing any two or more of the liquid tanks to be communicated with each other; and
a control device which controls the pressure decreasing device and the inflow passes, wherein
the control device controls the pressure decreasing device such that a pressure of any one of the liquid tanks is decreased and controls the inflow passes such that the liquid is flowed from the liquid tank which is not decreased in pressure into the other liquid tank which is decreased in pressure by the pressure decreasing device.

5. The degassing device according to claim 4, comprising:
three or more of the liquid tanks; wherein
the control device controls the pressure decreasing device such that a pressure of any one of the liquid tanks is decreased and controls the inflow passes such that the liquid is flowed from the liquid tank which is not decreased in pressure into the other liquid tank which is decreased in pressure by the pressure decreasing device.

6. The degassing device according to claim 5, wherein
the control device controls the pressure decreasing device to flow the liquid into the liquid tank which is decreased in pressure and then to maintain a pressure decreased state of the liquid tank which is decreased in pressure.

7. The degassing device according to claim 5, wherein
the control device controls such that approximately all amount of the liquid stored in the liquid tank which is not decreased in pressure is flowed into the other liquid tank which is decreased in pressure by controlling the pressure decreasing device.

8. The degassing device according to claim 1, wherein
the inflow pass includes a plurality of inflow ports through which the liquid is flowed into the liquid tank.

9. The degassing device according to claim 8, wherein
the inflow ports allow the liquid to be flowed in in a form of shower.

10. The degassing device according to claim 9, wherein
an opening diameter of the inflow port is 0.8 mm or less.

11. The degassing device according to claim 8, wherein
a number of the inflow ports is 25 or more.

12. An inkjet recording apparatus comprising:
the degassing device according to claim 1; and
a recording head which ejects the liquid degassed by the degassing device to a sheet.
